(19) United States
(12) Patent Application Publication
(10) Pub. No.: US 2018/0101998 A1
(43) Pub. Date: Apr. 12, 2018

(54) MANAGEMENT OF OPERATION AND USE OF RECREATIONAL VEHICLE

(71) Applicant: GPS SYSTEMS INTERNATIONAL PTY LTD, Victoria (AU)

(72) Inventors: Marvin PIERCE, Victoria (AU); Darren WOLCHYN, Victoria (AU)

(73) Assignee: GPS SYSTEMS INTERNATIONAL PTY LTD, Victoria (AU)

(21) Appl. No.: 15/567,143

(22) PCT Filed: Aug. 11, 2016
(86) PCT No.: PCT/AU2016/050727

§ 371 Date: Oct. 17, 2017

Related U.S. Application Data
(60) Provisional application No. 62/204,053, filed on Aug. 12, 2015.

(51) Int. Cl. G07C 5/00; G05D 1/02; G06F 17/30; A63B 55/60; G08G 1/0967; B60L 3/00

(52) U.S. Cl. CPC G07C 5/008; G05D 1/0274; G06F 17/3051; G06Q 50/30; G08G 1/096725; B60L 3/0015; G05D 2201/0204; A63B 55/60

(57) ABSTRACT

A system, and method, for managing recreational vehicle a central control unit (A) at a convenient facility and a unit (B) installable on a vehicle, with each unit (A) and (B) operable to receive data from and to send data to the other. Unit (A) includes a rules database module for holding an organised, searchable list of a rules database for control and management of a vehicle 12 on which a unit (B) is installed to comprise an on-vehicle unit B. The unit (A) also includes a rules engine module operable to receive, and compare with the rules list of database, data from the second unit (B). The unit (B) includes a location tracking module and a sensor data module, with the location tracking module adapted to track the position of the vehicle in real time by obtaining vehicle positional data, while the sensor data module is operable to collect data from at least one sensor of the vehicle and to pass the data to the unit (A).

### FIELD OF THE INVENTION

The present invention relates to a system and method for the management of the operation of a vehicle and of use of the vehicle and, in particular, for the individual management of each of a plurality of vehicles of a fleet of vehicles.

### BACKGROUND TO THE INVENTION

Individual and fleet owners of electric and internal-combustion powered recreational vehicles comprise those whose vehicles include, but are not limited to, golf carts, all-terrain vehicles (ATVs), utility task vehicles (UTVs) or recreational off-road vehicles (ROVs), such as quad bikes, dune buggies, resort carts and buggies, motorcycles, and other recreational land and snow vehicles, as well as water-craft such as boats and jet-skis, for public or private use. One of the largest uses of recreational vehicle rental fleets is of golf carts around public and private golf courses and associated areas and, in some instances, around resort property and planned community areas associated with golf courses. In golf and other applications, whether on private or public land, the vehicle owners require the ability to track, monitor and control the vehicles for reasons that extend to and beyond the following examples:
(a) Safety of vehicle users who may be unfamiliar with an area in which a vehicle is to be used, or who may have inadequate knowledge of how to use the specific vehicle safely—for example, it may be highly unsafe to operate the vehicle at high speed on a steep descent requiring the ability to limit the capability of the vehicle in such descent.
(b) Protection against damage to a vehicle due to driver error or misuse—for example, driving the vehicle in a congested area at high speed can lead to damaging collision with other vehicles or property structures such as buildings, signs or natural impediments such as trees, while vehicle damage can result from operating a vehicle on unlevelled or hilly terrain, or on loose surfaces such as gravel or in snow or icy conditions, which can cause a vehicle to roll-over, a particular risk with ATVs, UTVs and snow mobiles.
(c) Protection of the environment against driver error or misuse—for example, driving a golf cart onto the golf green can cause significant damage to the putting surface, requiring expensive repair, while driving in environmentally sensitive areas (such as areas of protected plant species) can cause irreparable damage and needs to be obviated.
(d) Prevention of driving vehicles into known restricted zones or areas in which driving the vehicle type is not legal or is contrary to regulations—for example many types of recreational vehicle are not licensed to operate on public roadways and are normally restricted to specific areas.
(e) Protection against vehicles being driven out of an approved area can thwart theft.
(f) Pre-emptively warning a driver of approaching or upcoming hazards—for example, operating a vehicle against the golf course flow may make it difficult to see sand traps or other hidden obstacles which could injure the vehicle occupants and/or cause significant damage to the vehicle.
(g) Accurate tracking logs of the vehicle travel history can be used to provide evidence of misuse of the vehicle as well as to assist in recouping costs for vehicle and environmental damage.
(h) Live accurate monitoring of the vehicles can be used to:
   (i) manually warn users of upcoming hazards;
   (ii) assist in locating vehicles and users in case of emergency;
   (iii) track and recover lost or stolen vehicles;
   (iv) provide journey replay;
   (v) provide GPS fleet management reporting;
   (vi) give an over speed notification;
   (vii) indicate detection of tampering.
(i) Any generated alerts can be displayed on a dashboard or, for more urgent issues, they can be sent to external notification systems such as:
   (i) SMS text message,
   (ii) App messages such as WhatsApp, Skype, iMessage, or
   (iii) Social Network messaging such as Facebook.
(j) Live accurate monitoring of the vehicles can enable owner/staff to:
   (i) assist vehicle users in the event of personal medical emergency;
   (ii) direct emergency services to a specific vehicle current location; or
   (iii) provide remote directional assistance to guide vehicle users when lost or in unfamiliar terrain.
(k) Accurate historical tracking logs can be used to map out areas of high/low vehicle usage, so maps can be used to:
   (i) change driving patterns;
   (ii) decrease vehicle use in high usage areas that may be damaging the environment; or
   (iii) use driving patterns for planning changes to current paths and addition of new paths, to better protect environmental issues against ongoing damage to turf cover, grasses and native vegetation.
(l) Tracking of vehicles can also be used to display different messages for users. The messages can be triggered by various methods for diverse locations, times, and/or dates. Examples of message types and their uses include:
   (i) advertising messages can include text, audio only, graphical, or full motion video ads;
   (ii) advertising can be used to increase revenue or to supplement the costs of the recreational vehicle or of the facility that owns or manages the fleet;
   (iii) alert messages can assist a responses to emergency events or to provide weather and personal safety warnings;
   (iv) directional messages are able to be triggered by driving into a specific area, and can indicate how to navigate from a current location to another location, such as a specific hole on the golf course, the club house or a restaurant within the resort;
   (v) alert messages can enable users to be warned of upcoming operational hazards that may pose a danger to the vehicle or its operator; and
   (vi) messages from third party applications and social media systems

There have been numerous previous proposals for systems and methods that enhance the use and driver control of road vehicles to increase safety and facilitate monitoring or regulating their use, whether they are individually owned and operated or part of fleet operation. There also have been previous such proposals applicable to recreational vehicles, in particular golf carts. In the latter case, proposals have been for the purpose of assisting users of the vehicles in their recreational activities, such as in assisting golfers by providing representations of course layouts and distances from current fairway locations to the next green. Some proposals for golf carts also have provided systems and methods for management of the operation of the golf carts of a fleet of such vehicles, such as for maintaining a service schedule for each cart of the fleet and to ensure timely maintenance and repair. Other proposals enable individual carts of a fleet to be supervised to ensure correct usage in respecting vehicle speed limits and appropriate observance of area restrictions, and to actuate corrective control of individual carts in order to enforce correct usage and observance by assuming control of the cart from its user.

The present invention seeks to provide an improved, or at least alternative, system and method for the management of the operation and/or use of individual recreation vehicles of a fleet of such vehicles.

### BROAD SUMMARY OF THE INVENTION

According to the present invention, there is provided a system for managing individual recreational vehicles. The system has two units, including a first unit comprising a central control unit locatable at a convenient facility and a second unit installable on a vehicle, with each of the two units operable to receive data from and to send data to the other of the two units. The first, central control unit includes a rules database module for holding an organised, searchable list of rules created for the control and management of a vehicle on which the second unit is installable to comprise an on-vehicle unit. The first unit also includes a rules engine module operable to receive, and compare with the rules list, data from the second unit. The second unit includes a location tracking module and a sensor data module. The location tracking module is adapted to track the position of the vehicle in real time by obtaining vehicle positional data while the sensor data module is operable, when the second unit is installed to comprise an on-vehicle unit, to collect data from at least one sensor of the vehicle and to pass the data to the first, central control unit. The second unit also includes a vehicle control interface module adapted for controlling at least one sensor of the vehicle. Additionally, the second unit includes a communication module by which data is transferable between the first and second units.

The invention also provides a method for managing at least one individual recreational vehicle, wherein the vehicle has a location tracking module, a sensor data module, a vehicle control interface module and a communication module, wherein the method includes the steps of:
(a) monitoring the vehicle position by the location tracking module, such as a u-blox NEO MN8 GPS module with external antenna available from u-blox Holding AG of Thalwil, Switzerland, to generate vehicle positional data;
(b) collecting the output from at least one sensor of the vehicle by the sensor data module to generate sensor data;
(c) passing the positional data from the location tracking module to the communication module;
(d) passing the sensor data from the sensor data module to the communication module; and
(e) passing the positional data and the sensor data in at least one data stream away from the vehicle and from communication module to a central control unit;
   wherein the central control unit is located remote from the vehicle and has a rules database module including a rules database holding an organised, searchable list of rules for the control and management of the vehicle, and a rules engine for receiving, and comparing with the rules list, data received from the communication module of the vehicle; and wherein the method further includes the step of:
(f) receiving, by the communication module from the central server, a message, or a command, or a message and a command in accordance with a rule activated by the central server in response to a comparison of data from the at least one stream with the rules engine and a resultant rule parameter match, with any message being made available to a driver of the vehicle and any command being communicated through the vehicle control interface module to at least one sensor of the vehicle for adjusting operation of the vehicle.

The system and method provided by the present invention enables real-time tracking, live monitoring and control of a single vehicle, or of each of individual vehicles of a fleet of vehicles currently in use. The system uses a group of modules, comprising the modules of the second unit when installed on the vehicle, or a respective group on each individual vehicle of the fleet, and a central server operating with an appropriate software system. The central server most preferably is a cloud based central server. The group of modules of a second unit installed on the, or each, vehicle can be contained in a single hardware device or, alternatively, the group of modules may be located across at least two devices that are interconnected together. The modules of a second unit installed on-vehicle are adapted to obtain current status data applicable to the vehicle, such as location and speed, as well as time of day, and to send the status data to the central server, and also adapted to receive commands and messages from the central server and to implement commands and communicate the messages. In real time the central server software is a system operable to manage the vehicle, or each vehicle independently, and to check and apply any triggered rules directly in the vehicle to perform desired or required actions.

The invention has particular application to vehicles comprising golf carts used by golfers, particularly in the course of playing a round of golf or in use around a golf club or facility, and the invention principally is described with reference to these applications. However, the invention also has application to golf carts when used for other purposes, such as use in a resort associated with a golf course. Additionally, the invention has application to types of recreational vehicles other than golf carts, in particular those vehicles used or operated as part of a fleet, such as by guests for movement around a resort property such as between accommodation sites, and between such sites and a reception area or resort facilities. In general, such vehicles are intended to be operated in a controlled manner and in observance of local navigational constraints or regulations, such as applicable on a golf course or in travel around a resort. However, the invention may be applicable to vehicles that are intended to be operated in a considerably more random manner, such as with off road vehicles, including all-terrain-vehicles (ATVs), utility-terrain-vehicles (UTVs) sometimes referred to as Side-by-Side vehicles, as well as scooters, motorcycles, quad bikes, dune buggies and motorised snow vehicles such as snow mobiles. Moreover, while principally directed to land vehicles, whether operable on two, three, four or more wheels, the invention also has application to recreational vehicles comprising watercraft, such as motor-powered boats and jet-skis.

In the above outlined applications both the system and method of the invention enable management of the operation and use of the vehicles whether the vehicles are intended to travel only on designated paths, roads, tracks or the like or the vehicles are able to depart from such course and roam more freely. Particularly in the latter case, the management may extend to vehicles that have travelled from a recreational area, such as of a resort or golf course, to an adjacent area such as to an adjacent public, residential or commercial area. However, the management also may be required in relation to vehicles on safari, whether on private or publicly owned land, or on farms and in other rural areas, such as through forests.

As used herein, a “command” denotes an instruction for control of a vehicle that is issued by the central server in response to data received by the central server, including data received via the vehicle control interface module from vehicle sensors, and that modifies at least one aspect of vehicle performance after passing via the vehicle control interface module to cause a change in operation of an output member of the vehicle. As such, a command can and typically does over-ride control of the vehicle otherwise able to be exercised by a driver of the vehicle. As used herein, a “message” denotes a communication that is issued or initiated by the central server for transmission via the vehicle control interface module to the driver of the vehicle for the purpose of alerting the driver of a need to observe an instruction concerning use of the vehicle, to observe a driving condition or restriction to be observed in use of the vehicle or to observe a combination of such instruction, condition and restriction, or a communication sent to a third party, or to both the driver and a third party. A message may, for example, be sent to both the driver and a third party, such as an administrator involved with provision of the vehicles, to provide an alert that a vehicle is being operated in a dangerous manner, or to inform that a lean angle limit has been exceeded with an ATV/UTV, enabling the third party to take response action. Thus, the central server may be adapted to generate alert messages in response to emergency circumstances that have occurred on the vehicle, such as in the event of a crash, roll over, detection of the vehicle being driven into a hazardous/restricted area, and an alert triggered manually from the driver of the vehicle. Such emergency circumstances usually would be detected by the central server from data received from the communication module of a vehicle. The central server may be adapted to act, on detecting an emergency circumstance, to generate an alert message and to send the alert signal to a dashboard, to another configured message system or to both a dashboard and such other system. The central server preferably is configured to send alert messages based on urgency of issue, and escalation of an alert message if an initial message has not been acknowledged and responded to. Alert messages preferably include location of event, information on drivers, local date and time.

The location tracking module of the second unit tracks the vehicle in real-time, typically with sub-second updates, and may comprise at least one of various location services. The service may be or include a GPS location service, or it may utilise a network triangulation system or service, or a system of location beacons in the geographic area in which the vehicle is to be used. The location tracking module is adapted to obtain location data for the vehicle via its own sensors or from at least one external sensor, and to forward the location data to the communication module. At least in the case of a GPS based location service, the location tracking module may optionally pass to the communication module additional data including the source and accuracy of the location data and the number of satellites from which the data were derived.

The second, on-vehicle unit also may include an external or secondary data module operable to collect external sensor data and to pass the external sensor data to the communication module for transmission to the first, central control unit. The external or secondary data may be that able to be received from at least one sensor such as an accelerometer; such as an LIS331HH low-power, high full-scale three axis MEMS linear “nano” accelerometer available from STMicroelectronics Pty Ltd, Australia. Alternatively, there may be used any type of inertial measurement unit (IMU) that includes a gyroscope, accelerometer and/or magnetometer for determining and reporting a vehicle's velocity, orientation and gravitational forces; as well as a local internal clock; a camera; or a sensor or respective sensor for recording vehicle speed, ambient temperature and/or vehicle motor temperature, voltage levels, audio input from the user and prevailing light level. The secondary data can be used in the rules database to create a flexible trigger system such as, for example, a trigger system for slowing a vehicle to a maximum speed of not more than a pre-set level, e.g., 5 or 10 kph, if the current lighting level is below a certain threshold.

The vehicle control interface module of the second, on-vehicle unit may control only the at least one sensor of the vehicle, but preferably controls two or more sensors of the vehicle. In each case, the vehicle control interface module may be adapted to activate at least one control mechanism, but preferably each of at least two of the various control mechanisms, of the vehicle or to send control messages directly to at least one, but preferable each of at least two, of the motor control systems of the vehicle. To enable this, the vehicle control interface module is adapted to receive commands from the first unit, and is able to be used to control the vehicle by at least one of several methods.

The first, central control unit may be a central server. The central server may, and most preferably does, comprise a cloud based central server. In each case, the central server receives data from the vehicle control interface module and from other sources that may be, and preferably are, independent of the vehicle control interface module and of other modules of the second unit. Also, in each case, the central server generates commands for controlling operation of the vehicle, and the commands generated in the central server are passed by the central server to, and accepted by, the vehicle control interface module. The control interface module is adapted to send, to respective sensors of the vehicle, commands received from the central server thereby to enable direct or indirect control of operation of the vehicle. The arrangement is such that communication between the vehicle control interface module and the central server enables the central server to receive from the control interface module substantially all data that is able to be derived from the vehicle concerning operation of the vehicle and that is required to enable the central server to generate substantially all commands necessary for control required to be exercised over operation of the vehicle.

All decisions on vehicle control most preferably are determined by, and on, the central server. From the central server the decisions giving rise to commands or messages are communicated remotely to the vehicle control interface module from which commands are sent to at least one vehicle sensor. Thus, commands may for example be sent by the control interface module to at least one of the ignition control, directional switch (forward/reverse), the throttle position sensor, the speed sensor, the brake sensor or an accelerometer sensor of the vehicle and for activating the pre-existing speed profile management in the speed sensor.

The commands sent to at least one sensor by the control interface module may be used to change the current speed profiles from the speed profile setting already programmed in the speed sensor of the vehicle. A vehicle comprising an electric golf vehicle, for example, typically has a speed sensor pre-set speed profile that the vehicle manufacturer, or a maintenance technician, uses to limit to the maximum speed for the vehicle. The manufacturer or technician is able to set or change the setting of the speed profile by use of high-cost specialist, hand-held programmer devices. A respective computer-controllable such device could be incorporated in each vehicle, and interfaced with a motor speed controller of the vehicle, to enable the vehicle to progress at a lower speed or even to stop the vehicle, negating input to the vehicle controls by the driver. Similarly, such on-board programmer device could be interfaced with other controllers of the vehicle, such as to enable operation of the braking system to slow or stop the vehicle or to enable steering adjustment in response to travel of the vehicle beyond a point and in a direction that would cause the vehicle to move into an unauthorised area. Similarly, provision of such as programmer device on each vehicle could enable a vehicle to be disabled or controlled in response to it being driven in an unacceptable manner, such as in tight turning circles over an area of soft ground, such as after heavy rainfall. However, the high capital cost involved with provision of a respective on-board programmer device in each vehicle is obviated by the present invention by the use of the central server to generate commands for such control, and to pass the commands to the appropriate sensors of the vehicle via the vehicle control interface module.

The substantial capital cost saving achieved by reliance on the central server to generate control demands is significant in itself. However, further capital and operating costs are able to be achieved. This results from the ease with which resources involved with the central server are able to be shared with two or more vehicle fleet operations located at respective locations, whether nearby, or widely separated such as in respective jurisdictions or countries, whether adjacent or remote. As indicated, the central server most preferably is cloud based and, where this is the case, its location is of reduced consequence, even where the central server is common to two or more vehicle fleet operations conducted at respective locations or in respective jurisdictions or countries. In any event, the central server is able to have capacity for handling a far greater volume and complexity of data processing and also a resultant ability to accommodate considerably more complex determinations than is possible with or practical for an on-board programmer device mounted on each vehicle, with the present invention therefore enabling much more complex forms of control of individual vehicles.

In addition to the central server generating commands for controlling the operation of a vehicle, it is able to generate respective such commands simultaneously for individual control each of the vehicles of a fleet. The central server it also is able to generate messages that are communicated to the vehicle, or simultaneously to each of two or more on the vehicles of the fleet, with the messages received by the vehicle control interface module of the, or the respective, vehicle. Such messages may be communicated to the driver of the vehicle, by way of a visual display and/or audio device, such as a tablet computer with an outdoor-readable screen and internal speakers. For enabling such message to be received, the system according to the invention may, and preferably does, have a driver presentation module able to present messages for the attention of the driver, although the system may be adapted for use with a presentation device already present of or able to be installed on the vehicle. The presentation module preferably provides a visual display, although it may comprise a non-visual, audio presentation. The presentation module may comprise a display screen with an audio output, preferably a display screen having a touch screen input. The presentation module may be adapted for presentation of general-purpose alerts or advertising material to the driver, while a microphone, camera or both a microphone and a camera optionally may form part of the presentation module.

Commands and messages generated by the central server are based at least in part on data on the operation of the vehicle communicated by the vehicle control interface module to the central server. To some extent, the central server is able to derive data from other sources for use in generating commands and messages. The central server is able to generate commands and messages that can be similar to those able to be generated by an on-board programmer device, although the greater computing power of which a central server is capable enables control of the vehicle that is able to be both more complex and more precisely timed. The commands received by the control interface module are able to be transmitted as electrical control signals that are passed to the relevant one or combination of two or more of the vehicle sensors, including throttle, speed, brake and accelerometer sensors and any inertial measurement unit such as discussed above. The electrical signals then are used to direct a change in vehicle operation, such as by causing a change in vehicle speed, applying the vehicle brakes or altering the steering of the vehicle, despite what the driver may have been seeking to attain in the course of operating the vehicle.

The communication module of the second unit is a wireless network device able to connect the vehicle control interface module and the central server. As previously indicated, the central server preferably is a cloud based server. To facilitate communicate with the central server, the communication module preferably is able to use existing standard wireless communication devices, such as those operating such as by Wi-Fi, or a 3G, 4G, 5G or later generations of mobile telecommunication technology or Bluetooth technology, or by a self-configuring network of mobile devices as with a mobile ad hoc network (MANET). The communication module preferable is used to authenticate, send/receive data and securely identify the, or each, vehicle to the central server.

The rules database module of the of the first, central control unit is an organised list of rules created by or on behalf of the owner and/or manager of a fleet of vehicles, for use in achieving required control and management of individual vehicles of the fleet that are in operation from time to time. Some rules may be time based such that, when a specific action is required to take place on at least one particular vehicle. At such time, the central server issues a command or message in accordance with the rule. Thus where, for example, the rules database contains a rule stipulating that a given advertisement is to be communicated to each vehicle in use at a set time on a particular day of each week, the central server sends out that message to all vehicles of the fleet that are not parked in their storage garage or being serviced. The rule may require that the message be sent only to vehicles that are mobile at that time and, for vehicles that stationary at the time, at the next opportunity after they again are mobile.

An aspect of the rules database module can be in the provision of rules responsive to a determination of unauthorised travel of a vehicle. For such determination, the central server receives relevant data from the vehicle control interface module of a vehicle, and makes an accurate measure in real time of the position, speed and travel direction of a vehicle, or respective position, speed and direction of travel of each of a plurality of vehicles, relative to a map covering at least the geographic area over which the, or each, vehicle is authorised to be driven. The data held in the memory of the central server includes not simply the total geographic area. The data also includes regions within the total geographic area, and preferably also at least the immediate vicinity around the total geographic area, which regions are distinguished as exclusion regions in which vehicles are not to be driven, such as putting greens of a golf course, bunkers, the rough and garden beds. The data may also include regions, distinguished as restricted regions, in which a reduced maximum speed, or a one-way travel direction, is to be observed, such as to minimise damage to water softened fairway surfaces and to minimise conflict with pedestrians due to travel of a vehicle adjacent to or within a pedestrian zone. In the event of a comparison showing a vehicle is projected to be likely to come into conflict with the need for observance of avoidance of an exclusion region, the central server issues a message to the presentation module via the vehicle control interface module, alerting the driver of the situation and requesting timely corrective action. In the event that the message is not promptly acted on by the driver, a further message may be issued if time permits, with the second message, and possibly the first message also, cautioning the driver that if the situation is not rectified coercive action will be enforced by issuance of an appropriate command that at least temporarily removes control over the vehicle from the driver. With the issuance of such a command, the command results in at least one appropriate sensor of the vehicle receiving an electrical signal from the control interface module which results in an adjustment in vehicle speed, steering direction, travel direction of reverse rather than forward, or a combination of such changes to attain correction of the conflict. The situation is similar in the event of a comparison showing a vehicle is projected to come into conflict with the need for observance of restricted regions. With commands necessitated by conflict with both exclusion and restricted regions, a command can be issued by the central server that results in a signal being passed by the control interface module to the control system of the motor of the vehicle that results in the motor being turned off, with the vehicle being immobilised, such as could be necessitated by an attempt to drive the vehicle away from the geographic area for its intended use, providing a possible safeguard against theft of the vehicle.

Another aspect of the rules database module can be in the provision of rules for driver-assisted navigation for driver safety, or for hazard avoidance and protection of equipment, environment such as a golf course, using vehicle-to-vehicle communication. When a specific type of rule from the rules database module (i.e. the determination of unauthorised travel of a vehicle into a zone) is triggered there can be multiple resulting commands sent back to the vehicle. If for example, the rules dictate that the vehicle needs to come to a complete stop and is only allowed to reverse out of a zone, a smart navigation feature can be activated that will determine any nearby hazards. If there exists a known environmental hazard like a golf course bunker (determined by the central server database of known mapped hazards, the driver of the vehicle can then be notified using a driver display to prevent a possible accident. In the case where a known hazard is within a very short distance behind the vehicles current location and the vehicle is set to “reverse only” control, the vehicle control interface can overrule the original command and allow the vehicle forward but on a suggested pathway out of the zone that triggered the original rules command. If allowance is required for the hazard being another vehicle, the system can include a vehicle-to-vehicle communication component to make sure another vehicle is not in the reversing path of vehicle to be subjected to reverse only control. With provision for vehicle-to-vehicle communication, the central server may have a rule for crash avoidance then when two or more vehicles are within the set minimum crash avoidance range of each other, enabling the central server to send a command to trigger vehicle-to-vehicle communication to those vehicles. Thus, the vehicles can be enabled then to start broadcasting, via a short-range wireless radio network, the location and direction of movement data of the vehicles. All vehicles that are within a set, limited range of the wireless transmission can then pick up the data from the other vehicles to process in the vehicle control interface. Each vehicle then can be able to predict the near term path(s) of the other vehicle(s) and compare that path to their own current direction, speed and location. If the vehicle control interface determines a collision will occur it can then alert the driver using a driver display and slow, or possibly even stop, the vehicle.

In one form of the system of the invention, provision is made for vehicle-to-vehicle communication, such as between golf carts deployed over a golf course. To enable this, each vehicle has integrated into its respective on-board unit “B” a wireless communication module, comprising a subcomponent of the existing communication module of the unit “B”, that is able to use an existing wireless communication technology. The wireless module for this purpose may be employ a technology that falls under the IEEE 802.15 or IEEE 802.11 specifications like Zigbee, Z-Wave and 6LoWPAN. An underlying protocol like IEEE 802.11p will provide for the low level wireless radio standards for the communication but the method for the interaction between the two or more vehicles will be system and feature dependent. For avoidance of conflict between vehicles, each vehicle could be enabled to send detailed data about its current GPS location as latitude, longitude and altitude, GPS data accuracy in meters, speed and compass direction to all other vehicles within range. This information would be sent as a single package of data containing the above mentioned numeric values including current date/time. This data would be constantly broadcasted to all surrounding vehicles on a specific update frequency, such as every 200 milliseconds, until the central server has determined these vehicles are not within a minimum distance of each other. If the central server determines that one or more of the vehicles are not within the minimum range it would send a new command to these vehicles to turn off the vehicle-to-vehicle communication protocol.

The central server typically includes, and most preferably does include, a broadcasting/communication hub module that facilitates very fast and steady communication between the rules engine of the central server and control interface module of the or each individual vehicle of the fleet of vehicles. It is highly desirable that this hub module enables secure, authenticated communication that prevents outside influence of interference. The central server also may include, and most preferably does include, one live dashboard display that provides a user interface that is updated by the broadcasting/communication hub module, to enable the or each vehicle to be monitored in real-time, or any convenient number of such displays. The, or each, live dashboard display preferably is a web based user interface that enables owners/operators of the vehicles to monitor the live location and status of each vehicle. The, or at least one, live dashboard display may enable direct interaction with each individual vehicle and/or its driver, or simultaneously with two or more vehicles and/or their drivers, to communicate a command and/or a message. Where the system and method of the invention has at least two live dashboard displays, the displays may be at the same location securely connected to the Internet, or each may be at a respective such location, and enable monitoring at any time and from anywhere a computer has Internet access. Any number of at least two live dashboard displays may be active at the one time, such as to enable different users to monitor operation with the system at the one time from the same or respective locations.

In order that the invention may more readily be understood, reference now is made to the accompanying drawings, in which:

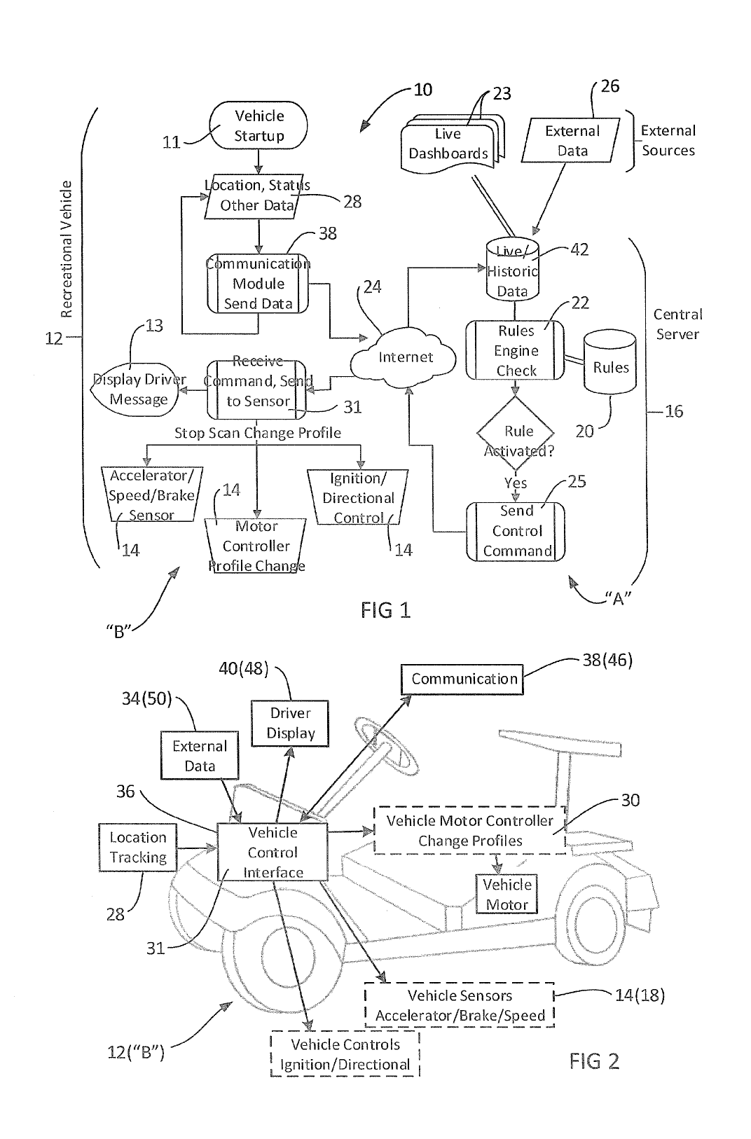

FIG. 1 is a system flowchart depicting a system according to the present invention;

FIG. 2 is a schematic depiction if a recreational vehicle, in this instance one suitable for use as golf or general purpose cart, suitable for use in the system of FIG. 1;

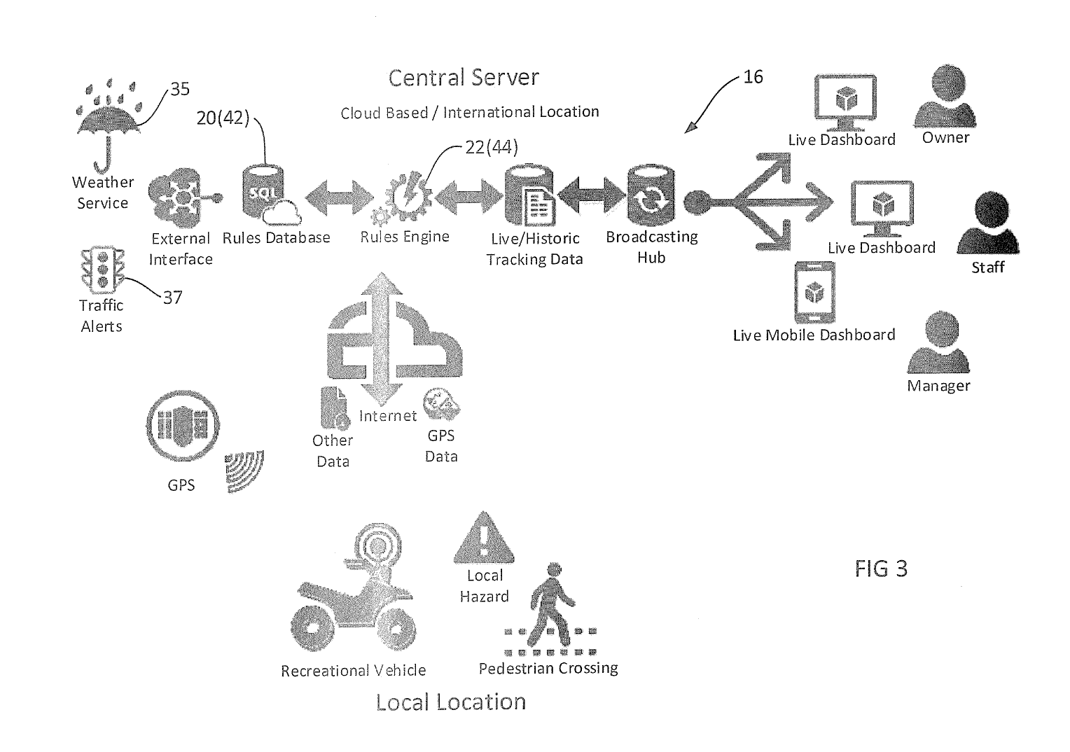

FIG. 3 is a schematic depiction of a central server suitable for use in the system of FIG. 1;

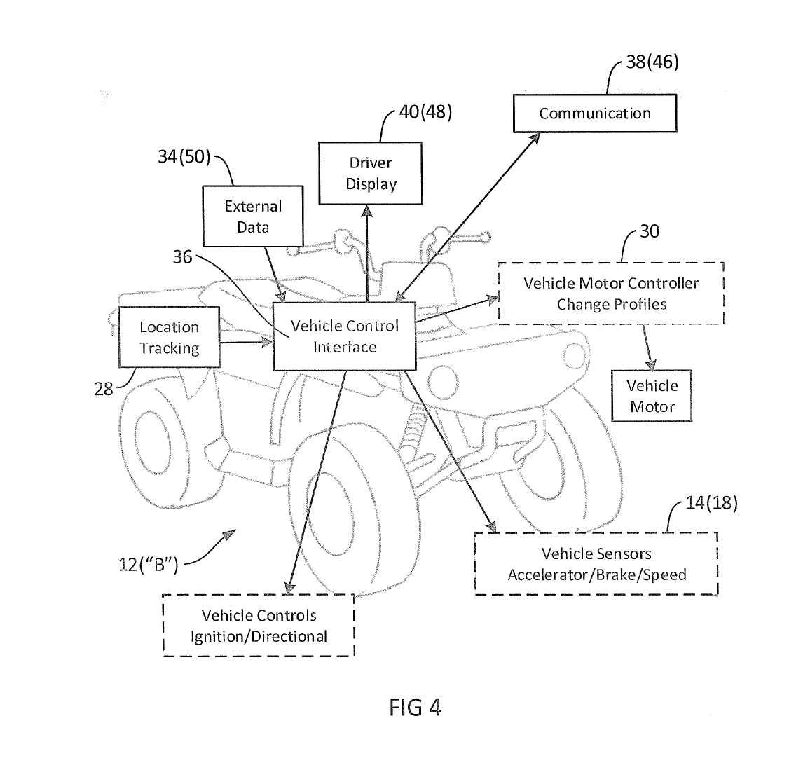

FIG. 4 is similar to FIG. 2, but illustrates a recreational vehicle of a form suitable for use as an ATV or UTV; and

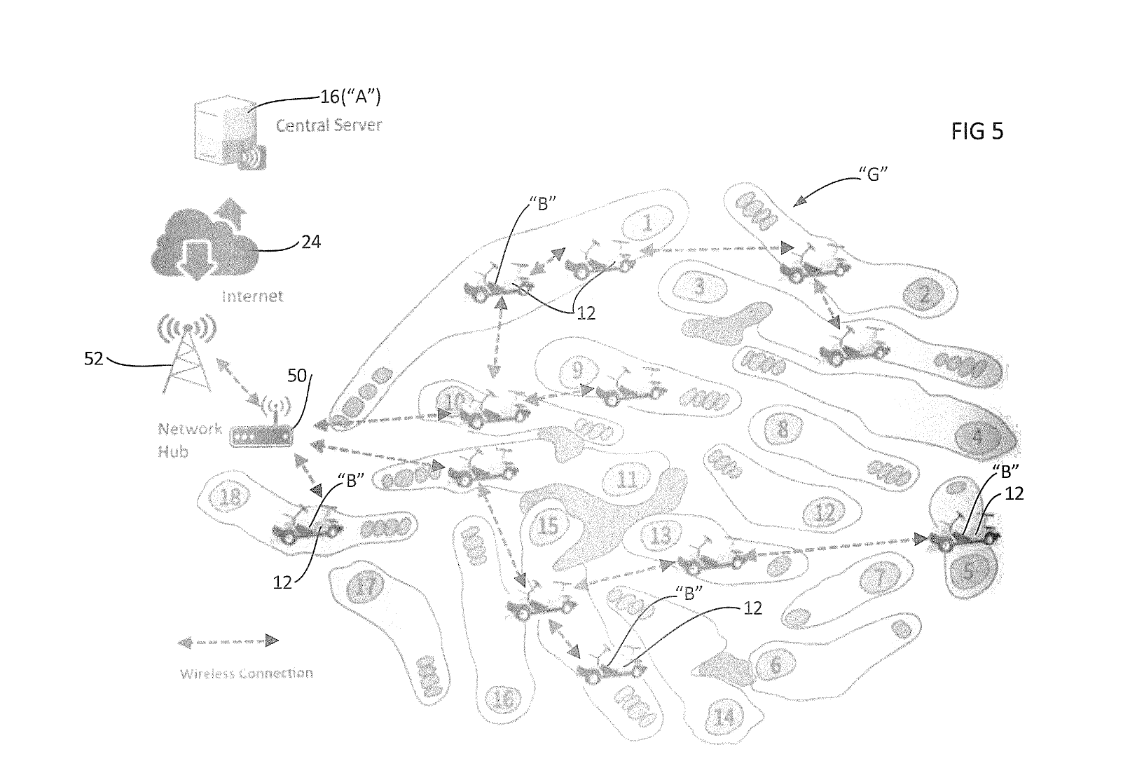

FIG. 5 is a schematic representation of a further system according to the present invention, illustrated in relation to control of vehicles comprising golf carts and having integrated therein a wireless cart-to-cart communication via a mesh network.

FIGS. 1 and 2 illustrate a system 10 for managing an individual recreational vehicle 12 as a single vehicle or as one of a fleet of vehicles, with the vehicle 12 shown comprising a golf cart. The overall system 10, as depicted in FIG. 1, has two types of units, including a first unit “A” comprising a central control unit “A” locatable at a convenient facility and a second unit “B” installable on a vehicle 12, as depicted in FIG. 2. In a typical, preferred arrangement applicable to a fleet of vehicles, a single unit “A” is operable with, and is common to, a multiplicity of units “B” with each unit “B” installed on a respective vehicle of the fleet. Each of the two units “A” and “B” is operable to receive data from and to send data to the other of the two units “A” and “B”.

The first, central control unit “A” includes a central server 16 that has a rules database module 42, a rules database 20 and a rules engine module 22. The rules database module 42 provides a database of records containing all historic recorded data sent from the system on vehicle 12 on which a second unit “B” is installed. The rules database module 42 also receives data on the current live status of the system of vehicle 12. This data is able to include, for example, geographic location, speed, battery levels, driver information, etc., with such data being recorded in live dashboards 23 of the central server 16. The dashboards may, for example, comprise active live views of the current status of each vehicle 12 of a fleet. The rules database module 42 is for holding an organised, searchable rules list of the rules database 20 created for the control and management of the vehicle 12. The rules engine module 22 may be in the form of an algorithm that uses current data from the vehicle 12 and is operable to receive data from the on-vehicle unit “B”, and compare that received data with the rules list of database 20, to determine if any action is required for the control of the vehicle 12. Action, in the form of a message or command, is sent from a send control command module 25 of the central server 16 via a remote cloud based server hosting environment depicted as “the internet” 24, to a receive command/send to sensor module 31 of the on-vehicle unit “B”.

The on-vehicle unit “B”, in addition to the command/send sensor module 31, includes a location tracking module 28 and a communications module 38. The location tracking module 28 includes a device, such as a GPS device, by which it is adapted to track the position of the vehicle in real time by obtaining vehicle positional data. The location tracking module 28 also is able to collect and interpret various data received onto the vehicle 12 from different available sensors and to filter and modify the data to a format or units of measure required by the central server 16 of unit “A”. The sensor data module 38 is operable to collect data from the module 28 and to transfer the data, via the internet 24, to the rules database module 42 of the first, central control unit “A”. The vehicle control interface module 31 of the unit “B” is adapted for controlling at least one of various sensors 14 of the vehicle 12, in accordance with commands received via the internet 24, from the send command/send to sensor module 31 of the first unit “A”. For this, the module 31 receives and checks commands sent from the central server 16 and interprets these commands into physical or electronic actions on the vehicle 12 to modify or change performance of the vehicle 12 by a change in the operation of a sensor 14 of the vehicle 12. A display module 13 is able to show messages to the driver of the vehicle 12, and may comprise an LCD touch display, LED lights and/or an audio communication or warning.

In use of the system 10, there is enabled a method for managing at least one individual recreational vehicle 12, such as a single vehicle or a selected individual vehicle 12 of a fleet of vehicles, wherein the vehicle 12 has an on-board unit “B” including a location tracking module 28, a sensor data module 31, a vehicle control interface module 31 and a communication module 38. The method includes the steps of:
(a) monitoring the position of the vehicle 12 by the location tracking module 28 to generate vehicle positional data;
(b) collecting the output from at least one sensor 14 of the vehicle 12 by the sensor data module 31 to generate sensor data;
(c) passing the positional data from the location tracking module to the communication module 38;
(d) passing the sensor data from the sensor data module 31 to the communication module 38;
(e) passing the positional data and the sensor data in at least one data stream away from the vehicle and from communication module to a central control unit “A” located remote from the vehicle.

The central control unit “A” has a rules database module 42 including a rules database 20 holding an organised, searchable list of rules for the control and management of the vehicle 12, and a rules engine module 22 for receiving, and comparing with the rules list, data received from the communication module 38 of the vehicle. The method further including the steps of:
(f) receiving, by the communication module 38 from the central control unit “A”, such as from a central server 16 of unit “A”, a message, or a command, or a message and a command, in accordance with a rule activated by the central control unit “A” in response to a comparison of data from the at least one stream with the rules engine module 22 and a resultant rule parameter match, with any message being made available to a driver of the vehicle 12 and any command being communicated through the vehicle control interface module 31 to at least one sensor 14 of the vehicle 12 for adjusting operation of the vehicle 12.

In FIG. 3, there is provided an alternative depiction of a system 10 that is similar to system 10 of FIGS. 1 and 2. In FIG. 3, components of the system 10 corresponding to components of system 10 of FIGS. 1 and 2 have the same reference numeral. In this instance, respective live dashboards 23 are shown for the owner/principle, a staff member and a manager, with the manager shown as having a live mobile dashboard 23 in contrast to the web page or PC dashboard 23 for the others. A database of records 42 contains all historic recorded data sent from the unit “B” on each golf cart vehicle 12, of which only one again is depicted, while the database of records also records current live status data of the vehicle 12. The central server system 16 has an external interface module 26 used to interface with various external sources, such as a source 35 of weather data and/or a source 37 of local traffic alerts. The module 26 can be configured to gain access to such outside services and to format and insert relevant information into the rules engine module 22 for interpretation, and to filter out non-relevant information. The external data services 35 and 37 kay be supplied via a standard web service.

As indicated in relation to FIGS. 1 to 3, the system 10 shown in FIG. 1 or FIG. 3 is for managing the movement of a vehicle 12, shown in FIG. 2. FIG. 4 shows an alternative form of vehicle 12 that is similar to that of FIG. 2, and FIGS. 2 and 4 use the same reference numerals for the similar features. The vehicle 12 of FIG. 2 comprises an individual golf cart that is part of a golf cart fleet, while FIG. 4 shows an ROV, a UTV or an ATV, although either may comprise another form of recreational vehicle for use on a golf course, residential area or on public or private land. The system 10 is operable to monitor the current geographic location of vehicle 12 and to centrally track the motion of vehicle 12 in real time based on various pre-set static rules. The rules may be based on current time and geographic region, or on dynamic rules that use external data such as traffic conditions, nearby hazards including other vehicles, maintenance equipment, warning and hazard wireless beacons, to slow and/or stop the motor of recreational vehicle 12, or allowing engaging of the reverse direction switch in the vehicle 12 or to cause a change to the maximum speed of vehicle 12 through the use of pre-set speed profiles already existent in a speed sensor comprising one of the sensors 14 of vehicle 12.

All decisions on the control of vehicle 12 by system 10 preferably are determined on the central server 16 of system 10. Control messages are remotely sent from central server 16 to an appropriate sensor 14 of vehicle 12. The sensors 14 are depicted collectively in each of FIGS. 2 and 4 by box 18 and can include an ignition control, throttle position sensor, speed sensor and/or brake sensor devices for activating a pre-existing speed profile management in a speed sensor. The decisions are determined by a list of rules 20, with the rules managed by a rules engine 22 and controlled on a central management server that is located offsite in a remote cloud based server hosting environment 24. The rules are maintained in real time so that changes can take effect instantaneously. Pre-set static rules are activated by proximity to a given one of no-go vehicle zones, that includes entry/exit zones, of geographic regions on a map maintained in the central server 16, as well as time of day or date based or cart usage rules, such as speed governing for the vehicle operator.

Real time dynamic rules can be activated by external data 26 link, covering such variables as density of vehicles 12 in one or more specific location, relative distance from a given vehicle to other equipment such as golf course lawn mowers and other maintenance equipment, and general environmental data, including current weather conditions, traffic data when vehicles are being used on public land, connected site sensors, such as sensors for moisture content of golf course fairways.

The location of a given vehicle 12 can be determined by an on board GPS device 28 built into the engine control unit (ECU) 36 or, alternatively by a triangulation service that use wireless networks or the vicinity of recreational vehicle 12 to location beacons. All the carts contain an electronic module, such as an control unit 36, or a computer or tablet, that continuously streams the location data of the module in real time to the central server 16, over any wireless network, such as a Bluetooth or Wi-Fi network, or by 3G, 4G, 5G or later generation mobile telecommunication technology.

When the rules engine 22 of the cloud-based central server 16 determines that a rule has been triggered, the rules result is activated and the relevant control commands are sent back from the central server over a wireless network to the ECU 36 to pass through to the vehicles throttle position sensor, speed sensor, brake sensors, directional switch (forward/reverse) and ignition control to either change to a different speed profile, slow, stop and/or limit the movement of the cart or, to directly cut power to the carts/recreational vehicle motor.

As shown in FIGS. 1 and 2, the system 10 of the invention, and the method for its use, that enables historical tracking, live monitoring and individual recreational vehicle 12 or each vehicle of a fleet of recreational vehicles 12, within a mapped area, comprises two distinct units. These are a central control unit “A” shown in FIG. 1 (and similarly in FIG. 4) and an on-vehicles unit “B” shown in FIG. 2. The on-vehicle unit “B” comprises a group of modules installed on each individual vehicle 12, while the control unit “A” comprises a cloud based central server software system.

The modules of the unit “B” can be contained in a single hardware device or across different devices that are interconnected together. The main functions of the modules of the on-vehicle unit “B” are to;
(i) obtain for the respective vehicle 12 its current status, in terms such as location, speed and direction of the vehicle 12, as well as external parameters such as the date and local time of day;
(ii) send the status data to the central server; and
(iii) receive control command and messages back from server to implement those commands/control on the vehicle.
   The cloud based central server software is a system used to manage the fleet of vehicles 12, to monitor the vehicles 12 in real time and to check and apply any triggered rules directly to the vehicle to perform desired actions.

The modules of the on-vehicle unit B″ include a location tracking module 28. The function of module 28 is to track the recreational vehicle 12 in real-time, preferably with sub-second updates, using any one or combination of various location services including GPS tracking, network triangulation; and tracking by means of vicinity to location beacons. The module 28 obtains the location data via its own sensors and/or from external devices and forwards to a communication module 38 of unit “B”, preferably in sub-second intervals. Additional data is also is able to be included, such as the source of location data, the accuracy of the data, and the number of satellites relied on in the case of GPS tracking.

The on-vehicle unit “B” also includes an external or secondary data module 34 that is used to collect and pass any other external sensor data to the cloud based central server 16. The external or secondary data may be that able to be received from at least one sensor such as an accelerometer, a local internal clock or a camera, or a sensor or respective sensor for recording vehicle speed, ambient temperature and/or vehicle motor temperature, voltage levels, audio output of the vehicle and prevailing light level. The external or secondary data can be used in the rules database to create a flexible trigger system such as, for example, a trigger system for slowing a vehicle to a reduced maximum speed, such as if the current lighting level falls below a certain threshold.

Also, the unit “B” includes a vehicle control interface module 36 able to activate various control mechanisms of the vehicle 12, such as to start the vehicle motor, while module 36 also is able to send selected, appropriate control sensors of the vehicle 12 commands received by the module 36 from the remote cloud based central server 16. The commands received by module 36 from the central server 16 are used to control the vehicle by several methods. All decisions for the control of vehicle 12 are determined on the central server 16 and control commands and messages are remotely sent, as appropriate for control to be exercised, to the ignition control for vehicle 12, the throttle position sensor, the speed sensor and/or the brake sensor devices, for activating the pre-existing speed or other profile management in the speed or other sensor. Thus, command or messages can be used to change the current speed profiles already programmed in the vehicle's speed sensor. For example, with an electric golf vehicles 12 with a sensor having speed profiles pre-set by the vehicle maintenance staff, the pre-set limits on the speed of the vehicle 12 can be adjusted by a command from the central server 16. That is, the pre-set profiles can be managed as appropriate by installation of alternative profiles. The control interface would also be able activate existing features of the vehicle that are used for controlling the speed and safe use off the vehicle. For example putting the vehicle in reverse or connecting a resistance across the motor while travelling forward is automatically managed to slow and stop the vehicle before reverse will start working (known respectively as plugging braking and dynamic braking) or, alternatively, where motor speed exceeds synchronous speed, causing the motor to work as a generator (for regenerative braking) to more quickly stop the vehicle. The system would be able to trigger these features on the vehicle when deemed necessary.

The vehicle control interface module 36 can be used to send electrical control signals to the built-in sensors on the recreational vehicle, in accordance with commands received by module 36 from the central server 16. The sensors can include the throttle, speed, brake, steering or accelerometer sensors. The electrical signals are used to direct the vehicle to change speed or direction, or to actuate the braking system. The control interface module 36 also can be used to directly connect/disconnect several of the vehicles internal electrical control signals or devices, including the main ignition key switch and the directional control switches that switch between forward and reverse travel. This permits the remote cloud based central server to turn the vehicle on/off or restrict the direction of movement based on the vehicle sensors.

The vehicle control interface module is able to connect with the cloud based central server 16 by means of a communication module 38 of the on-board unit “B”. The module 38 is a wireless network device that can provide the connection using an existing standard wireless communication devices, such as by Wi-Fi, by 3G, 4G, 5G or later mobile technology, or by Bluetooth technology. Module 38 is used to authenticate, send/receive data and securely identify the vehicle to the central server.

A driver display module 40 of the on-board unit “B” is provided for use in displaying any messages, alerts or advertising to the operator of the vehicle. The module consists of a display screen, audio output and touch input interface. A microphone and camera are additional optional components.

The central control unit “A” includes a rules database module 42 as shown in FIG. 3, with module 42 having a rules database providing an organized, searchable list of rules 20 (see FIG. 1) created by the vehicle owner/manager for use in controlling and managing the vehicle 12 of a fleet. When a specific action is required to take place on the vehicle 12, a specific rule stored in the rules database is activated to ensure that the resultant action takes place on a selected one or more the vehicles 12 of a fleet. The rules database typically would include a web based user interface so people with system permission can access and manage the rules. Also, a rules engine 44 of the unit “A” takes in information from the or each vehicle 12, such as location, date and local time of day, driver details, environmental data including local weather, as well as output from at least one of a gyroscope, an accelerometer and external sensors, and compares this data to the current list of applicable rules. If the parameters of a rule are met then the resultant action is sent to the vehicle, and all of this can be logged and recorded for future reference.

A broadcasting and communication hub module 46 of the central control unit “A” is used to facilitate very fast and steady communication between the rules engine 44 and each individual vehicle 12 of a fleet that is in use. The communication needs to be secure and authenticated to prevent any outside influence. The broadcasting and communication hub module 46 is able to send status updates to anyone viewing a live dashboard display 48 so that the vehicles 12 of a fleet can be monitored in real time.

An external data interface module 50 of the central control unit “A” is used to receive data from external systems that can be used by the rules engine and database. This data can include current weather conditions or current traffic conditions for a certain locale.

The live dashboard display 48 is a web based user interface by which where all the owners/managers of the fleet of vehicles 12 can monitor the live location and status of any one or more vehicle 12 of the fleet. The display also permits direct interaction with each individual vehicle 12, or two or more vehicles 12 at the same time to send messages and/or control the, or each, vehicle 12. There can be more than one display active at one time from any location securely connected via the Internet. This allows the managers and owners of the vehicles 12 to monitor the system 10 at any time and from anywhere a computer has Internet connection. Multiple people are able simultaneously to monitor the same vehicle or fleet from different locations and mobile devices.

As detailed earlier herein, vehicle-to-vehicle communication can be integrated into the system 10 of the invention, such as to enable operation of at least one vehicle to be controlled by the central server. FIG. 5 illustrates schematically the use of mesh networking providing vehicle-to-vehicle communication to inter-connect a multiplicity of golf carts 12 distributed over a golf course “G”. Communication between the carts 12 is depicted by the broken line arrows, with two-way communication between the respective unit “B” of each vehicle active in the network and the central server 16 of the unit “A” able to proceed through a wireless network hub 50, via a high gain antenna 52. To facilitate communication with the central server 16 the communication module (not depicted) could implement the mesh network topology to use the fleet of carts to create and maintain a wireless network between all the carts back to the central network hub 50 conveniently located at the golf clubhouse. The central hub 50 is operable to use a broadband Internet connection to connect all the carts 12 to the central web based server 16. With a fleet of carts 12 spread randomly across a golf course, an ad hoc network using short range wireless radios that only need to have a range sufficient to connect to the next nearest cart. This range can be in the distance of 100's of meters to be able to create and maintain the network for all the carts on a course. This eliminates the costly use of 3G/4G/5G data connections. Various existing technologies that fall under the IEEE 802.15 or IEEE 802.11 specifications like Zigbee, Z-Wave and 6LoWPAN could be used in the carts to facilitate this network model.

1-46. (canceled)

47. A system for managing an individual recreational vehicle, wherein the system has two units, including:
a first unit comprising a central control unit locatable at a convenient facility, and
a second unit installable on a vehicle, each of the two units are operable to receive data from and to send data to the other of the two units; the first, central control unit includes:
(i} a central server;
(ii) a rules database module for holding an organised, searchable list of a rules database created for the control and management of a vehicle on which the second unit is installable to comprise an on-vehicle unit: and
(iii) a rules engine module operable to receive, and compare with the rules list of database, data from the on-vehicle second unit;
the second unit includes:
(a) a location tracking module adapted to track the position of the vehicle in real time by obtaining vehicle positional data:
(b) a sensor data module operable to collect data from at least one sensor of the vehicle;
(c) a vehicle control interface module adapted for controlling the at least one sensor of the vehicle in accordance with a command from the first central control unit; and
(d) a communication module by which data is transferable between the first unit and second unit;
wherein:
the central control unit of the system is adapted to utilize data received from the second unit in providing real-time tracking, live monitoring and real-time control of the vehicle on which
the second unit is installed;
the modules of the second unit are adapted to Obtain current status data applicable to the vehicle, such as location, speed, and time of day, and to send the status data to the central server, and also adapted to receive commands, or messages or commands and messages, from the central server and to implement commands and communicate the messages; the central server is a cloud based central server having a software system operable in real time to manage the vehicle by checking, and applying directly in the vehicle, any commands or messages in accordance with triggered rules necessitated by the current status data to forward to the modules of the second unit actions: for performance, respectively, of required or desired a “command” denotes an instruction for control of the vehicle that is issued by the central server of the central control unit in response to data received by the central server, including data received via the vehicle control interface module from vehicle sensors, and that modifies at least one aspect of vehicle performance after passing via the vehicle control interface module to cause a change in operation of an output member of the vehicle and, if appropriate, to over-ride at least part of control of the vehicle otherwise able to be exercised by a driver of the vehicle; and
a “message” denotes a communication issued or initiated by the central server for transmission via the vehicle control interface module to the driver of the vehicle for the purpose of alerting the driver of a need to observe an instruction concerning use of the vehicle, to observe a driving condition or restriction in use of the vehicle or to observe a combination of such instruction, condition and restriction.

48. The system according to claim 47, wherein the system is adapted to enable real-time tracking, live monitoring and control of each of Individual vehicles of a fleet when currently in use, each vehicle of the fleet having a respective said on-board second unit, and the cloud based central server operating with a software system enabling respective checking and applying to each vehicle of any triggered rules necessitated by the respective current status for each vehicle to forward to the modules of the respective second unit to perform respective desired or required actions.

49. The system of claim 47, wherein the modules of a second unit installed on-vehicle are adapted to obtain current status data applicable to the vehicle, such as location and speed, as well as time of day, and to send the status data to the central server, and also are adapted to receive commands and messages from the central server and to implement commands and communicate messages, and wherein the central server software is a system operable in real time to manage the vehicle, or each vehicle independently, and to check and apply any triggered rules directly in the vehicle to perform desired or required actions.

50. The system of claim 47, wherein the location tracking module of the second unit tracks the vehicle in real-time, typically with sub-second updates, and may comprise at least one of various location services such as at least one of a GPS location service, or a network triangulation system or service, or a system of location beacons in the geographic area in which the vehicle is to be used, and wherein the location tracking module is adapted to obtain location data for the vehicle via its own sensors or from at least one external sensor, and to forward the location data to the communication module, and wherein the location service is or includes a GPS based location service, and the location-tracking module is operable to pass to the communication module additional data including the source and accuracy of the location data and the number of satellites from which the data were derived.

51. The system of claim 47, wherein the on-vehicle second unit includes an external or secondary data module operable to collect external sensor data and to pass the external sensor data to the communication module for transmission to the first, central control unit; the external or secondary data is able to be received from at least one sensor such as an accelerometer, a local internal clock or a camera, or a sensor or respective sensor for recording vehicle speed, ambient temperature and/or vehicle motor temperature, voltage levels, audio input from the driver of the vehicle and prevailing light level; and the secondary data can be used in the rules database to create a flexible trigger system such as a trigger system for slowing a vehicle to a maximum speed.

52. The system of claim 47, wherein the control interface module is adapted to send, to respective sensors of the vehicle, commands received from the central server thereby to enable direct or indirect control of operation of the vehicle, such that communication between the vehicle control interface module and the central server enables the central server to receive from the control interface module substantially all data that is able to be derived from the vehicle concerning operation of the vehicle and that is required to enable the central server to generate substantially all commands necessary for control required to be exercised over operation of the vehicle.

53. The system of claim 47, wherein all decisions on vehicle control are determined by and on the central server, and from the central server the decisions giving rise to commands or messages are communicated remotely to the vehicle control interface module from which commands are sent to at least one vehicle sensor whereby commands are able to be sent by the control interface module to at least one of the ignition control, the throttle position sensor, the speed sensor, the brake sensor or an accelerometer sensor of the vehicle and for activating the pre-existing speed profile management in the speed sensor.

54. The system of claim 53, wherein the vehicle comprises a golf vehicle, that has a speed sensor pre-set speed profile set by the vehicle manufacturer, or a maintenance technician, use to limit to the maximum speed for the vehicle, and wherein the central server is adapted to generate commands for setting or changing the speed profile of the speed sensor, and to pass the commands to the appropriate sensors of the vehicle via the vehicle control interface module.

55. The system of claim 47, wherein commands received by the control interface module are able to be transmitted as electrical control signals that are passed to the relevant one or combination of two or more of the vehicle sensors, including throttle, speed, brake and accelerometer sensors, with the electrical signals then used to direct a change in vehicle operation, such as by causing a change in vehicle speed, applying the vehicle brakes or altering the steering of the vehicle, despite what the driver may have been seeking to attain in the course of operating the vehicle.

56. The system of claim 47, wherein the communication module of the second unit is a wireless network device able to connect the vehicle control interface module and the central server, the communication module optionally able to use existing standard wireless communication devices, such as those operating such as by or by 3G, 4G, 5G or later generations of mobile telecommunication technology or Bluetooth technology, such as with the communication module used to authenticate, send/receive data and securely identify the, or each, vehicle to the central server.

57. The system of claim 47, wherein the rules database module provides rules responsive to a determination of unauthorised travel of a vehicle by the central server receiving relevant data from the vehicle control interface module of a vehicle and making an accurate measure in real time of the position, speed and travel direction of the vehicle, or respective position, speed and direction of travel of each of a plurality of vehicles, relative to a map covering at least the geographic area over which the, or each, vehicle is authorised to be driven.

58. The system of claim 47, wherein the central server includes a broadcasting/communication hub module that facilitates very fast and steady communication between the rules engine of the central server and control interface module of the or each individual vehicle of the fleet of vehicles, such as with the hub module enabling secure, authenticated communication that prevents outside influence or interference.

59. The system of claim 58, wherein the central server includes at least one live dashboard display that provides a user interface that is updated by a broadcasting/communication hub module, to enable each vehicle to be monitored in real-time, or any convenient number of such displays, with a live dashboard display being a web based user interface that enables owners or operators of the vehicles to monitor the live location and status of each vehicle.

60. A method for managing at least one individual recreational vehicle, using a system including a first unit providing a remotely located central control unit comprising a cloud based central server and having a rules database module having a rules database holding an organised, searchable list of rules for the control of management of the vehicle, the system further including an on-hoard second unit installed on the vehicle and having a location tracking module, a sensor data module, a vehicle control interface module adapted for controlling at least one sensor of the vehicle in accordance with a command from the central control unit, and a communication module, the central control unit being adapted to utilise data received from the second unit in providing real-time tracking, live monitoring and real-time control of the vehicle on which the second unit is installed; wherein the method includes the steps of:
(i) monitoring the position of the vehicle by the location tracking module to generate vehicle positional data;
(ii) collecting the output from at least one sensor of the vehicle by the sensor data module to generate sensor data;
(iii) passing the positional data from the location tracking module to a communication module;
(iv) passing the sensor data from the sensor data module to the communication module;
(v) passing in real-time the positional data and the sensor data in at least one data stream from communication module and from the vehicle to the central control unit; and
wherein the method further includes the steps of:
(vi) receiving in real-time, by the communication module from the central control unit a message, or a command, or a message and a command, in accordance with a rule activated by the central control unit in response to a comparison of data from the at least one stream with a rules engine module and a resultant rule parameter match, with any message being made available to a driver of the vehicle and any command being communicated through the vehicle control interface module to at least one sensor of the vehicle for adjusting operation of the vehicle in real-time;
wherein a “command” denotes an instruction for control of the vehicle that is issued by the central server of the central control unit in response to data received by the central server, including data received via the vehicle control interface module from vehicle sensors, and that modifies at least one aspect of vehicle performance after passing via the vehicle control interface module to cause a change in operation of an output member of the vehicle and, if appropriate, to over-ride at least part of control of the vehicle otherwise able to be exercised by a driver of the vehicle; and
wherein a “message” denotes a communication issued or initiated by the central server for transmission via the vehicle control interface module to the driver of the vehicle for the purpose of alerting the driver of a need to observe an instruction concerning use of the vehicle, to observe a driving condition or restriction in use of the vehicle or to observe a combination of such instruction, condition and restriction.

61. The method of claim 60, wherein in step (vi) the communication module receives a command comprising an instruction for control of the at least one vehicle that is issued by the central server in response to data received by the central server, including data received via the vehicle control interface module from vehicle sensors, and that modifies at least one aspect of vehicle performance after passing via the vehicle control interface module to cause a change in operation of an output member of the vehicle, the command can over-ride control of the vehicle otherwise able to be exercised by a driver of the vehicle; and the communication module receives any message comprising a communication that is issued or initiated by the central server for transmission via the vehicle control interface module to the driver of the vehicle for the purpose of alerting the driver of a need to observe an instruction concerning use of the vehicle, to observe a driving condition or restriction to be observed in use of the vehicle or to observe a combination of such instruction, condition and restriction, or a communication sent to a third party, or to both the driver and a third party.

62. The method of claim 60, wherein the location tracking module of a second unit tracks the vehicle in real-time, typically with sub-second updates, utilising a GPS location service, or a network triangulation system or service, or a system of location beacons in the geographic area in which the vehicle is to be used.

63. The method of claim 60, wherein the central server generates commands for controlling operation of the vehicle, and the commands generated in the central server are passed by the central server to, and accepted by, the vehicle control interface module, and the control interface module sends, to respective sensors of the vehicle, commands received from the central server thereby to enable direct or indirect control of operation of the vehicle whereby communication between the vehicle control interface module and the central server enables the central server to receive from the control interface module substantially all data that is able to be derived from the vehicle concerning operation of the vehicle and that is required to enable the central server to generate substantially all commands necessary for control required to be exercised over operation of the vehicle.

64. The method of claim 63, wherein decisions on vehicle control are determined by and on the central server, with central server decisions giving rise to commands or messages communicated remotely to the vehicle control interface module from which commands are sent to at least one vehicle sensor, whereby commands are sent by the control interface module to at least one of the ignition control, directional forward/reverse switch, the throttle position sensor, the speed sensor, the brake sensor or an accelerometer sensor of the vehicle and for activating the pre-existing speed profile management in the speed sensor.
